(19) United States
(12) Patent Application Publication
(10) Pub. No.: US 2025/0332849 A1
(43) Pub. Date: Oct. 30, 2025

(54) PRINTING DEVICE

(71) Applicant: PRIMAX ELECTRONICS LTD., Taipei City (TW)

(72) Inventors: SHU-YI LIN, Taipei City (TW); Yen-Sheng Wang, Taipei City (TW); Wen-Lung Hung, Taipei City (TW); Yi-Lun Wei, Taipei City (TW); Bo Li, Taipei City (TW)

(21) Appl. No.: 18/661,738

(22) Filed: May 13, 2024

(30) Foreign Application Priority Data
Apr. 30, 2024 (CN) 202410544620.5

(51) Int. Cl. B41J 11/00; B41J 15/02; B41J 15/04; B41J 29/48

(52) U.S. Cl. CPC B41J 11/0095; B41J 15/02; B41J 15/042; B41J 29/48

(57) ABSTRACT

A printing device includes a paper roll carrying base and a distance sensor. The paper roll carrying base includes a paper roll accommodation space and two paper clamping arms. The two paper clamping arms are opposed to each other and installed in the paper roll accommodation space. A paper roll is clamped by the two paper clamping arms. The distance sensor is disposed on a bottom surface of the paper roll accommodation space. The distance sensor faces the paper roll. A paper roll distance between the paper roll and the distance sensor is detected by the distance sensor. A remaining amount of the paper roll is estimated according to the paper roll distance.

### FIELD OF THE INVENTION

The present invention relates to the field of a commercial printing technology, and more particularly to a printing device.

### BACKGROUND OF THE INVENTION

As known, thermal printers or thermal copiers use thermal paper rolls as printing media. Due to their small sizes and fast printing characteristics, thermal printers or thermal copiers have been widely used in supermarkets, shopping malls, telecommunications, hospitals and other fields in order to print item details and related charges of goods or medicines for customers or patients.

Most commercially available thermal printers or thermal copiers support paper rolls with the inner diameter of 0.5 to 1 inch. In addition, paper rolls with different widths may be equipped with paper cores with different inner diameters.

Conventionally, in order to detect the remaining amount of the paper roll, a detection module is usually installed on a paper clamping arm of a paper roll carrying device. In addition, the remaining amount of the paper roll is detected in a light-blocking manner. However, since the inner diameters of the paper cores of different paper rolls are not always identical, the detection module installed on the paper clamping arm cannot accurately measure the remaining amount of paper rolls with different sizes. Since the user is unable to replace the paper roll with a new one before the paper roll is used up, the printing operation is inconvenient to the user.

In order to overcome the drawbacks of the conventional technologies, it is important to provide a printing device for quickly detecting the remaining amount of paper rolls with paper cores of different inner diameters and with different sizes.

### SUMMARY OF THE INVENTION

An object of the present invention provides a printing device, especially a commercial thermal printer or a commercial thermal label machine.

In accordance with an aspect of the present invention, a printing device is provided. The printing device includes a paper roll carrying base and a distance sensor. The paper roll carrying base includes a paper roll accommodation space and two paper clamping arms. The two paper clamping arms are opposed to each other and installed in the paper roll accommodation space. A paper roll is clamped by the two paper clamping arms. The distance sensor is disposed on a bottom surface of the paper roll accommodation space. The distance sensor faces the paper roll. A paper roll distance between the paper roll and the distance sensor is detected by the distance sensor. A remaining amount of the paper roll is estimated according to the paper roll distance.

In an embodiment, the printing device further includes a control module. When a paper roll remaining amount detection program is executed by the control module, a paper roll remaining amount detection process is performed. The paper roll remaining amount detection process includes steps of: (a) reading a paper core information about the paper roll and loading a preset threshold value corresponding to the paper roll, (b) detecting the paper roll distance, and (c) judging whether the paper roll distance is larger than or equal to the preset threshold value. If the paper roll distance is larger than or equal to the preset threshold value, an insufficient remaining amount message is generated. If the paper roll distance is smaller than the preset threshold value, a step (d) is performed. In the step (d), a printing standby process is performed, and then a printing operation is performed. In a step (e), the step (b) is performed again after the printing operation is completed.

In an embodiment, the printing device further includes an input interface. The paper core information about the paper roll is inputted by a user through the input interface.

In an embodiment, the printing device further includes a prompting module. The prompting module generates a prompt signal according to the insufficient remaining amount message.

In an embodiment, the distance sensor is a proximity sensor or a laser distance-measuring module.

From the above descriptions, the printing device is equipped with a distance sensor. The distance sensor is disposed on the bottom surface of the paper roll accommodation space to quickly detect the remaining amount of paper rolls with paper cores of different inner diameters and with different sizes. Moreover, since the distance sensor is disposed on the bottom surface of the paper roll accommodation space rather than the paper clamping arm, the assembling complexity and the fabricating cost of the printing device will be effectively reduced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of a printing device according to an embodiment of the present invention;

FIG. 2 is a schematic perspective view illustrating the structure of a paper roll carrying base of the printing device according to the embodiment of the present invention;

FIGS. 3A and 3B schematically illustrate the operations of the distance sensor in the printing device according to the embodiment of the present invention; and

FIG. 4 is a flowchart illustrating a method for detecting the paper roll remaining amount according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

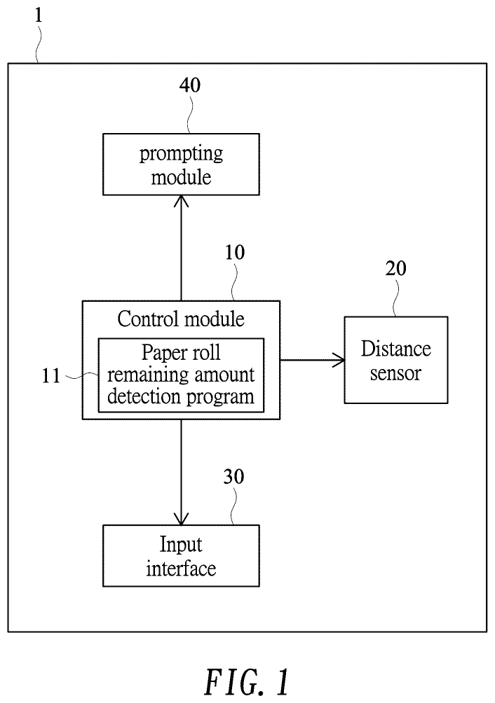

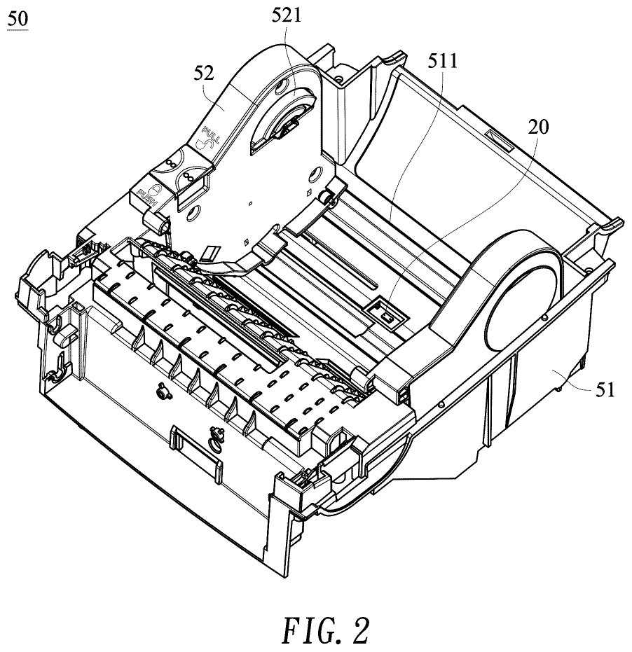

Please refer to FIGS. 1 and 2. FIG. 1 is a schematic functional block diagram illustrating the architecture of a printing device according to an embodiment of the present invention. FIG. 2 is a schematic perspective view illustrating the structure of a paper roll carrying base of the printing device according to the embodiment of the present invention.

In an embodiment, the printing device 1 comprises a control module 10, a distance sensor 20, an input interface 30, a prompting module 40 and a paper roll carrying base 50.

A paper roll remaining amount detection program 11 is stored in the control module 10. When the paper roll remaining amount detection program 11 in the control module 10 is executed, a paper roll remaining amount detection process is performed.

The paper roll carrying base 50 comprises a base housing 51 two paper clamping arms 52. The base housing 51 comprises a paper roll accommodation space 511. In addition, two supporting mechanisms 521 are respectively installed on the two paper clamping arms 52, and the two supporting mechanisms 521 are opposed to each other. The two paper clamping arms 52 are disposed within the paper roll accommodation space 511. In addition, the two paper clamping arms 52 are slidably or temporarily fixed at a specified position or an arbitrary position in the paper roll accommodation space 511. The two paper clamping arms 52 can be used to clamp paper rolls with different sizes. For succinctness, the paper rolls to be clamped by the paper clamping arms 52 are not shown. When a paper roll is accommodated within the paper roll accommodation space 511, the paper core (not shown) of the paper roll is supported and fixed by both of the supporting mechanisms 521. The distance sensor 20 is disposed on the bottom surface of the paper roll accommodation space 511. In addition, the distance sensor 20 faces the paper roll (not shown). Preferably but not exclusively, the distance sensor 20 is a proximity sensor or a laser distance-measuring module.

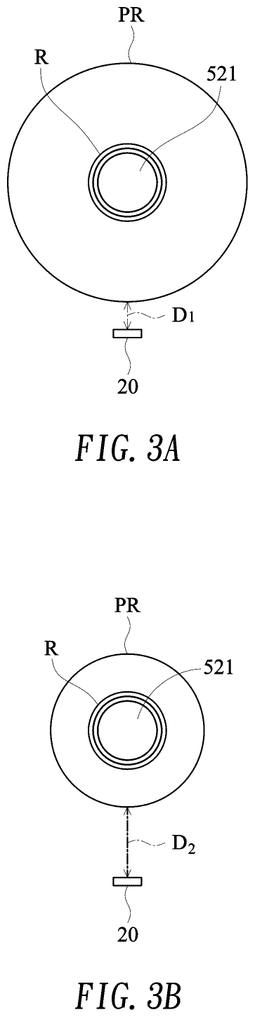

Please refer to FIGS. 3A and 3B. FIGS. 3A and 3B schematically illustrate the operations of the distance sensor in the printing device according to the embodiment of the present invention. As shown in FIGS. 3A and 3B, the paper roll PR has a paper core R. The supporting mechanisms 521 are inserted into a channel of the paper core R to support and fix the paper core R of the paper roll PR. The distance sensor 20 is used to detect a paper roll distance D1 (shown in FIG. 3A) or a paper roll distance D2 (shown in FIG. 3B) between the paper roll PR and the distance sensor 20. According to the paper roll distance D1 or the paper roll distance D2, the remaining amount of the paper roll PR can be estimated. In the situation of FIG. 3A, the detected remaining amount of the paper roll PR is larger, and thus the paper roll distance D1 is shorter. In the situation of FIG. 3B, the detected remaining amount of the paper roll PR is less, and thus the paper roll distance D1 is longer.

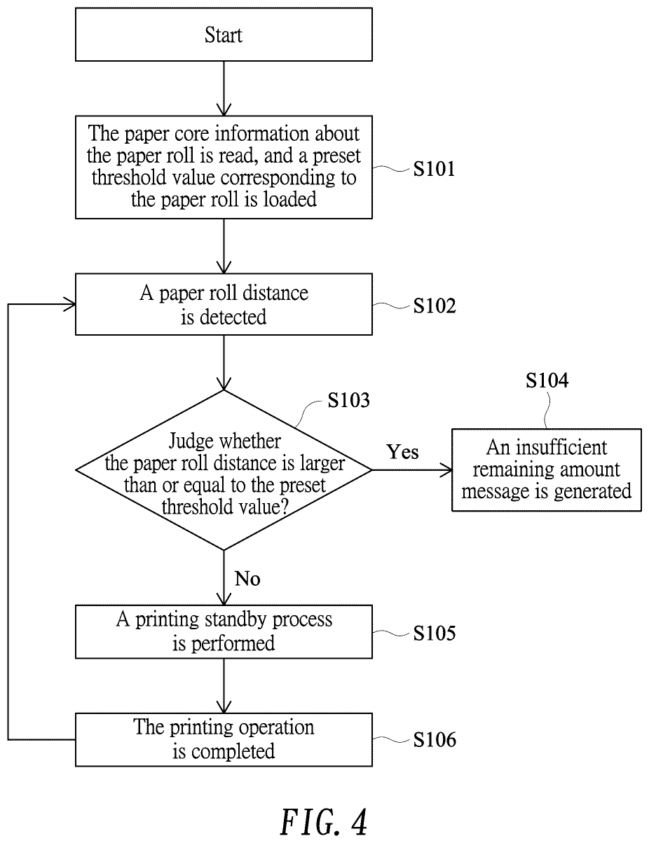

Please refer to FIGS. 1 and 4. FIG. 4 is a flowchart illustrating a method for detecting the paper roll remaining amount according to an embodiment of the present invention. Firstly, a paper roll is loaded into the printing device 1. Then, an upper cover (not shown) of the printing device is closed. Then, the information about the paper roll (or the paper core corresponding to the paper roll) is inputted by the user through the input interface 30. For example, the information includes the size model of the paper roll. In some other possible embodiments, a corresponding size detection module (not shown) is installed on the supporting mechanism 521 shown in FIG. 2. The information about the paper roll (or the paper core corresponding to the paper roll) is detected and acquired by the size detection module.

Please refer to FIG. 4. When the paper roll remaining amount detection program 11 in the control module 10 is executed, the paper roll remaining amount detection program 11 performs a paper roll remaining amount detection process. The paper roll remaining amount detection process comprises the following steps.

Firstly, the paper core information about the paper roll is read, and a preset threshold value corresponding to the paper roll is loaded (Step S101). In the step S101, the paper roll accommodation space 511 as shown in FIG. 2 has a fixed depth, but the inner diameters of the paper cores R of different paper rolls PR are not always identical (e.g., in the situation of FIG. 3A or the situation of FIG. 3B). For example, the inner diameter of the paper core R of the commercial paper roll PR is 1.5 inch, 1 inch or 0.5 inch. In case that the inner diameter of the paper core R is larger, the overall thickness of the paper roll PR is thinner, and the corresponding preset threshold value of the paper roll PR is smaller. In case that the inner diameter of the paper core R is smaller, the overall thickness of the paper roll PR is thicker, and the corresponding preset threshold value of the paper roll PR is larger. For example, the overall thickness of the paper roll PR and the paper core R is fixed. If the inner diameter of the paper core R is 0.5 inch, the preset threshold value is 77 mm. If the inner diameter of the paper core R is 1 inch, the preset threshold value is 67 mm. If the inner diameter of the paper core R is 1.5 inch, the preset threshold value is 47 mm. For example, the preset threshold value is previously stored in the printing device according to the inner diameter of the paper core R of the commercial paper roll PR. Alternatively, the preset threshold value is set by the user through the input interface 30 shown in FIG. 1.

Then, a paper roll distance is detected (Step S102). In the step S102, the distance sensor 20 is used to detect a paper roll distance D1 (shown in FIG. 3A) or a paper roll distance D2 (shown in FIG. 3B) between the paper roll PR and the distance sensor 20.

Then, a step S103 is performed to judge whether the paper roll distance is larger than or equal to the preset threshold value.

If the judging condition of the step S103 is satisfied, an insufficient remaining amount message is generated (step S104). For example, in the situation of FIG. 3B, the paper roll distance D2 is greater than or equal to the preset threshold value. Consequently, in the step S104, the prompting module 40 generates a prompt signal according to the insufficient remaining amount message. For example, the prompt signal is a sound signal or a light signal to warn the user. According to the prompt signal, the user realizes that the remaining amount of the paper roll is possibly insufficient when the printing operation is performed, and it is needed to replace the paper roll with a new one as soon as possible.

If the judging condition of the step S103 is not satisfied, a printing standby process is performed (Step S105). For example, in the situation of FIG. 3A, the paper roll distance D1 is smaller than the preset threshold value. In the step S105, the user can perform the printing operation at any time. At the end of the printing operation, the printing operation is completed (step S106). Then, the step S102 is performed again to detect the change of the paper roll distance after the installed paper roll is consumed through the printing operation.

From the above descriptions, the printing device 1 is equipped with a distance sensor 20. The distance sensor 20 is disposed on the bottom surface of the paper roll accommodation space 511 to quickly detect the remaining amount of paper rolls with paper cores of different inner diameters and with different sizes. Moreover, since the distance sensor 20 is disposed on the bottom surface of the paper roll accommodation space 511 rather than the paper clamping arm 52, the assembling complexity and the fabricating cost of the printing device 1 will be effectively reduced. In other words, the printing device of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A printing device, comprising:
a paper roll carrying base comprising a paper roll accommodation space and two paper clamping arms, wherein the two paper clamping arms are opposed to each other and installed in the paper roll accommodation space, and a paper roll is clamped by the two paper clamping arms; and
a distance sensor disposed on a bottom surface of the paper roll accommodation space, wherein the distance sensor faces the paper roll,
wherein a paper roll distance between the paper roll and the distance sensor is detected by the distance sensor, and a remaining amount of the paper roll is estimated according to the paper roll distance.

2. The printing device according to claim 1, wherein the printing device further comprises a control module, wherein when a paper roll remaining amount detection program is executed by the control module, a paper roll remaining amount detection process is performed, wherein the paper roll remaining amount detection process comprises steps of:
(a) reading a paper core information about the paper roll, and loading a preset threshold value corresponding to the paper roll;
(b) detecting the paper roll distance;
(c) judging whether the paper roll distance is larger than or equal to the preset threshold value, wherein if the paper roll distance is larger than or equal to the preset threshold value, an insufficient remaining amount message is generated, wherein if the paper roll distance is smaller than the preset threshold value, a step (d) is performed;
(d) performing a printing standby process, and then performing a printing operation; and
(e) performing the step (b) again after the printing operation is completed.

3. The printing device according to claim 2, wherein the printing device further comprises an input interface, wherein the paper core information about the paper roll is inputted by a user through the input interface.

4. The printing device according to claim 2, wherein the printing device further comprises a prompting module, wherein the prompting module generates a prompt signal according to the insufficient remaining amount message.

5. The printing device according to claim 1, wherein the distance sensor is a proximity sensor or a laser distance-measuring module.
